(19) United States
(12) Patent Application Publication
(10) Pub. No.: US 2015/0039467 A1
(43) Pub. Date: Feb. 5, 2015

(54) Print Service Matching

(71) Applicants: Sunil Kothari, Palo Alto, CA (US); Ehud Chatow, Palo Alto, CA (US)

(72) Inventors: Sunil Kothari, Palo Alto, CA (US); Ehud Chatow, Palo Alto, CA (US)

(21) Appl. No.: 14/364,733

(22) PCT Filed: Apr. 13, 2012
(86) PCT No.: PCT/US2012/033548

§ 371 Date: Jun. 12, 2014

(51) Int. Cl. G06Q 30/06; G06Q 30/02; G06F 3/12

(52) U.S. Cl. CPC G06Q 30/0613; G06F 3/1253; G06Q 30/0283; G06F 3/1203; G06F 3/1226; G06F 2206/1504
USPC 705/26.41

(57) ABSTRACT

A print service system including a first stage module to set non-price service terms between a buyer and print service providers, and a second stage module to produce price-based terms between the buyer and one print service provider.

### BACKGROUND

With the advent of the information age, the market for printing services has grown rapidly in size and diversity. As in other industries, a buyer can solicit and receive quotes or bids from printing vendors regarding a potential job order. Sorting through the wide variety of bidders can be time consuming, and may or may not produce the best vendor for a particular job.

### BRIEF DESCRIPTION OF THE DRAWINGS

FIG. 1 is a diagram schematically illustrating an example print service system.

FIG. 2 is a block diagram schematically illustrating an example server of an intermediary of the example print service system.

FIG. 3A is a flow diagram schematically illustrating an example method of facilitating print services.

FIG. 3B is a block diagram schematically illustrating an example capabilities profile.

FIG. 4 is a block diagram schematically illustrating an example second stage module of a server.

FIG. 5 is a partial flow diagram schematically illustrating an example method of facilitating print services.

FIG. 6 is a flow diagram schematically illustrating an example method of facilitating print services.

FIG. 7A is a block diagram schematically illustrating an example manager of a print service system.

FIG. 7B is a block diagram schematically illustrating an example server.

FIG. 8A is a block diagram schematically illustrating an example buyer.

FIG. 8B is a block diagram schematically illustrating an example print service provider.

FIG. 9 is a flow diagram schematically illustrating an example method of facilitating print services.

FIG. 10 is a block diagram schematically illustrating an example print service system.

### DETAILED DESCRIPTION

In the following detailed description, reference is made to the accompanying drawings which form a part hereof, and in which is shown by way of illustration specific examples and embodiments of the present disclosure that may be practiced. In this regard, directional terminology, such as “top,” “bottom,” “front,” “back,” “leading,” “trailing,” etc., is used with reference to the orientation of the Figure(s) being described. Because components of the examples and embodiments can be positioned in a number of different orientations, the directional terminology is used for purposes of illustration and is in no way limiting. It is to be understood that other examples and embodiments may be utilized and structural or logical changes may be made without departing from the scope of the present disclosure. The following detailed description, therefore, is not to be taken in a limiting sense.

Embodiments of the present disclosure are directed to providing an intermediary between a buyer and print service providers to enable a negotiation process to be performed in multiple stages. In one example, the intermediary operates a server including a registry and a manager. The registry stores a capability profile of each print service provider of a plurality of print service providers. The manager includes a first stage module and a second stage module. The first stage module identifies matches, while excluding price information, between the capability profile of the respective print service providers and a job inquiry from a buyer and to set non-price service terms. The second stage module provides a path for a price-based negotiation with one matching print service provider to produce a price-based services level agreement, incorporating the non-price service terms, between the buyer and the one matching print service provider.

In one example, the non-price service terms employed in the first stage are preset by the intermediary, and therefore, are not negotiable between the buyer and the print service providers. However, the intermediary has the ability to modify the non-price service terms from time-to-time.

In one example, the non-price service terms on which matching is based forms a first service level agreement between the buyer and the print service providers because neither the buyer nor the print service providers can proceed to the second stage without consenting to, or agreeing to, the non-price service terms.

In one aspect, after the first stage (I), the buyer selects one matching print service provider with which to enter into price-based negotiations. Moreover, if desired, the system can shield the identity of the buyer in the first stage of communications.

Among other benefits, the print service system of the present disclosure prevents a price war at the outset of bidding by print service providers, and instead, acts to ensure that there is first a match between the demands of the buyer and the capabilities of the print service provider before any communications or posturing regarding price can occur.

Moreover, the registry of the example print service system also acts to filter out less reputable print service providers because, in order to be eligible for the first and second stages of negotiation with a buyer, the print service providers has to first be listed on the registry as a qualified participant. Via the registry and the non-price communications in the first stage, the print service system prevents a race-to-the-bottom price competition by the print service providers that might otherwise occur. Such race-to-the-bottom environments can be dominated by the largest or most aggressive print service providers with price as the main consideration, and therefore, these environments do not contribute to a robust and diverse market of print service providers.

To enhance quality as a determining factor in selection of a print service provider prior to the second stage price-based negotiations, in one example, the registry that stores the capability profiles of the print service providers also stores a performance rating of each print service provider. In general terms, the performance rating is based on the print service provider's performance on past jobs. In one example, the intermediary assigns an initial performance rating and as the print service provider participates in the system, the performance rating is updated according to buyer feedback and assessments by the intermediary. In one aspect, intermediary sets a threshold score for the performance rating in order for print service provider to be eligible to be listed in the registry.

Besides possibly inundating a buyer with too much sales-driven information, such price wars tend to result in some buyer's orders going unfulfilled because the print service providers are chasing the most profitable jobs or highest volume jobs first. On the other hand, the example print service system of the present disclosure helps to restore order out of chaos and empowers a buyer to make quality choices among a wide variety of similarly-equipped print service providers before addressing price concerns.

In some examples, the second stage module enables the buyer to negotiate with one matching print service provider, either with the server (of the intermediary) hosting the negotiation or with the buyer negotiating directly with the print service provider and independent of the server of the intermediary. In one aspect, these negotiations include offers and counter-offers between the buyer and one print service provider, which in turn, achieves a more vibrant and robust transaction between the buyer and print service provider. Otherwise, in existing bid systems, the buyer is left with the simple choice of accepting or rejecting a bid without the opportunity for a dynamic, back-and-forth negotiation. In one aspect, the offers and counter-offers taking place during negotiation in examples of the present disclosure enable the participants to vary multiple parameters in addition to varying price factors during negotiations.

However, in another example, the second stage module enables the intermediary to act on behalf of the buyer with via server participating in an electronic, automatic negotiation process with the one matching print service provider according to a price profile set by the buyer. In this latter example, the intermediary receives a selection by the buyer of the one matching print service provider or alternatively, the server of the intermediary automatically selects the one matching print service provider with whom to negotiate.

In some examples, the intermediary of the example print service system provides a mechanism for addressing unfulfilled orders by aggregating several previously unfulfilled orders into an aggregated job, for which bids are then solicited via the example multi-stage negotiation process. In another example, instead of the intermediary soliciting bids, the intermediary automatically notifies the print service providers of the existing of an unfulfilled job or of an aggregated job to which the print service provider can response.

In another example, if an unfulfilled order comprises an aggregated job, then the aggregated job is disassembled into separate jobs, which are submitted separately to the multi-stage negotiation process of the example print service system. In one aspect, the process of aggregating and/or disassembling jobs is repeated, as appropriate, until all the jobs are fulfilled. Alternatively, a buyer can withdraw a job if desired.

In some examples, the intermediary provides a feedback function by which a print service provider periodically makes performance reports regarding the job requests that it executes. In another example, the intermediary provides a feedback function to survey the buyer regarding the performance of the print service provider regarding a job or group of jobs. These feedback functions provide a feedback loop so that buyers, the intermediary, and the print service providers consistently become more knowledgeable regarding the actual performance of print service providers as well as regarding the preferences of buyers. In one aspect, this performance information is combined to produce the earlier described performance rating that is stored in the registry for each print service provider. Moreover, these feedback functions of an example print service system of the present disclosure address a challenge, in existing print service markets, of the participants having too little performance information on which to base their respective decisions.

Together, the components of the example print service system of the present disclosure help to restore order and meaningful buyer participation in the ultra-competitive print services market.

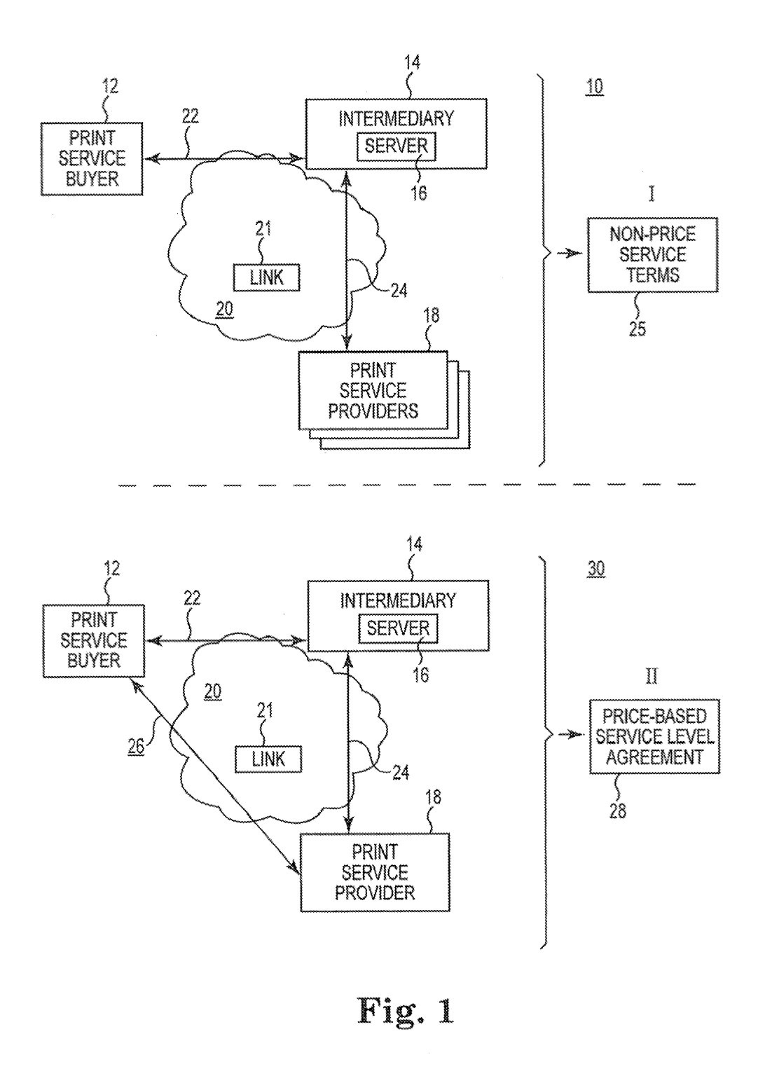

These examples, and additional examples, are described in association with FIGS. 1-9.

FIG. 1 is a diagram schematically illustrating an example print service system 10 of the present disclosure. As shown in FIG. 1, the system 10 includes a print service buyer 12, an intermediary 14 including a server 16, and multiple print service providers 18, which communicate with each other electronically via the cloud 20, along the respective communication paths 22, 24. In one example, the cloud 20 represents a network communication link 21 such as the internet, other network-based communication protocols, mobile telecommunication networks, local area networks (LAN), wide area networks (WAN), etc.

In general terms, print service system 10 provides for a multi-stage process by which an intermediary 14(acting via a server 16) facilitates interaction between the buyer 12 and print service providers 18 to arrive at a service level agreement between the buyer 12 and one of the print service providers 18. Accordingly, FIG. 1 illustrates both a first stage (I) of and a second stage (II) of interaction between the buyer and print service provider(s) 18 regarding print services.

As shown in FIG. 1, in the first stage (I) the buyer 12 does not communicate directly with print service provider(s) 18. Rather, buyer 12 communicates directly with intermediary 14 while print service provider(s) 18 communicate directly with intermediary 14. In one aspect, this arrangement prevents buyer 12 from being initially inundated with a high volume of communications from multiple print service providers 18 and so that the print service providers 18 first focus on the terms of service to be provided, rather the speed with which they can induce the buyer 12 to accept their bid. In another aspect, this arrangement provides each print service provider 18 with an infrastructure by which to manage communications with buyer 12 and intermediary 14. Moreover, with this arrangement, the buyer 12 benefits from additional information and search capabilities provided via intermediary, such as performance ratings, location proximity, etc. regarding each print service provider 18.

Using the arrangement in stage one (I), the intermediary 14 facilitates the buyer 12 to identify which print service providers 18 are capable of meeting non-price service terms 25 that will result in prompt and effective completion of the requested print job. These matching print service providers 18 become eligible for a second stage (II) of interaction with the buyer 12. However, in one example, buyer 12 selects just one print service provider 18 with which to interact in the second stage.

In the second stage (II), the intermediary 14 provides pathways for the buyer 12 and one matching print service provider 18 to negotiate toward a final price-based agreement regarding the job inquiry presented by the buyer 12. In one example, this final agreement is expressed in a price-based service level agreement 28 (SLA). As shown in stage two (II) in FIG. 1, in one example of this arrangement, the buyer 12 is capable of directly communicating with the one matching print service provider 18 with whom the price-based negotiations are conducted.

In one example, buyer 12 operates in system 12 via a computer (e.g. laptop, desktop, etc.), a mobile computing device (e.g. smartphone, tablet, etc.), and like devices capable of communicating via cloud 20. The buyer 12 can be an individual consumer, a business or other entity. It will be further understood that system 10 can handle multiple buyers 12 operating in parallel with each buyer 12 independently making their own job inquiries.

In one example, a job inquiry includes a print job request with some parameters regarding a quantity, type of printing, print medium etc. In some examples, the job inquiry includes the content to be printed (and/or copied, finished, shipped, etc.) while in other examples, the job inquiry omits the content to be printed with the content provided at a later time after the buyer 12 enters a service level agreement with one of the print service providers 18.

In one example, the buyer 12 includes a print service provider that uses system 10 to meet a print job for that print service provider's own customers. This situation can occur when the print service provider does not have a particular capability requested by their consumer or when the print service provider seeks to buy extra capacity via system 10.

In one example, print service provider 18 includes an entity owning and/or operating a print shop having printers and related devices for printing the job requested by buyer. In one aspect, the print services include printing, copying, finishing, assembly, delivery, shipping and related tasks.

In one example, intermediary 14 is a third party relative to buyer 12 and print service providers 18 and does not provide its own printing services. In other examples, intermediary 14 comprises a print service provider that acts in a capacity as a broker between the buyer 12 and multiple print service providers 18. Moreover, the intermediary 14 operates a publically accessible portal, such as a web site, supported by server 16 and through which both the buyer 12 and print service providers 18 can communicate via the cloud 20 to use system 10.

Further details regarding the intermediary 14, the interaction of the buyer 12 and print service providers 18, and the print service system 10 as a whole, are described in association with FIGS. 1-9.

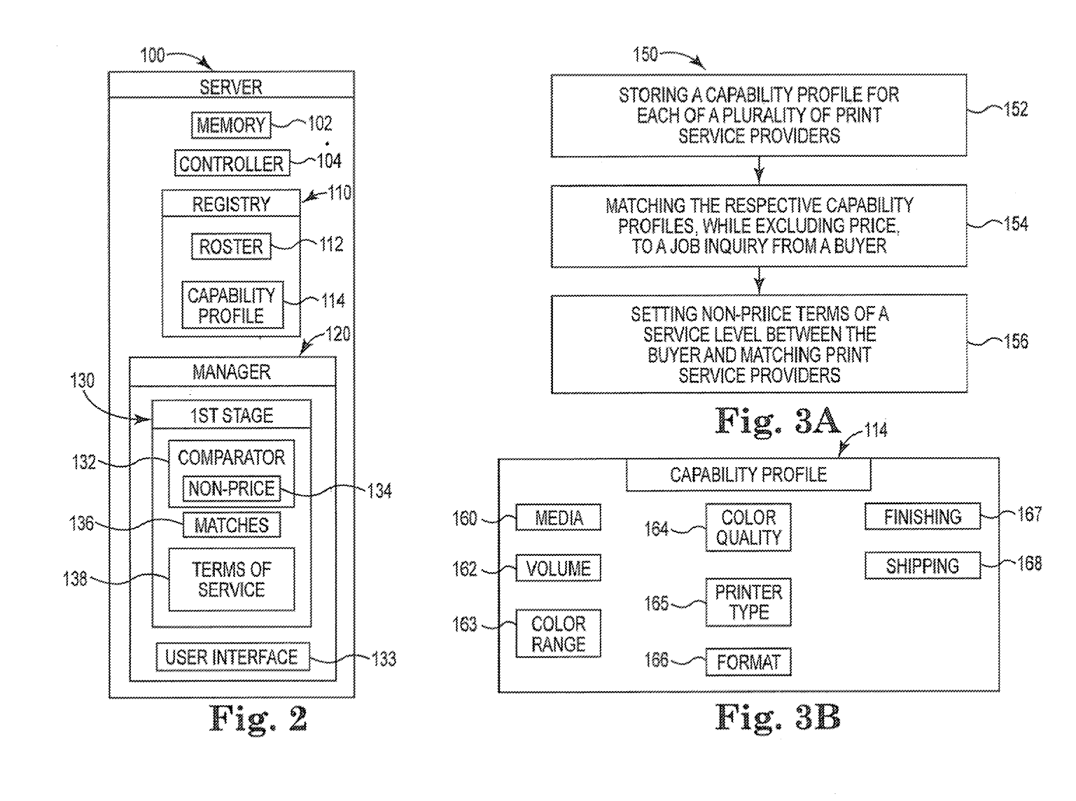

FIG. 2 is a block diagram of an example server 100 of a print service system. In one example, server 100 comprises at least substantially the same features and attributes as server 16 previously described in association with FIG. 1. In general terms, the intermediary 14 acts (via servers 16, 100) to provide the control and infrastructure to support electronic communications and interactions between the buyer 12 and print service providers 18.

As shown in FIG. 2, the server 100 includes a memory 102, a controller 104, a registry 110, and a manager 120.

In general terms, registry 110 stores a listing of print service providers 18 with whom a buyer 12 can interact and possibly form a service level agreement. In one example, the registry 110 includes a roster 112 of print service providers and their associated capabilities as tracked via capability profile function 114. In order to qualify for the roster 112, each print service provider 18 needs to meet an array of qualifications set by the server 100. In one example, these qualifications have a high degree of correspondence with at least the non-price service terms 25 sought by a buyer in the first stage (I in FIG. 1) of interaction with the print service providers 18. The capability profile function 114 tracks the capabilities of each print service provider 18, such as the type of printer (e.g. laser, inkjet), types of finishing, scale of printing (e.g. volume per day or per job), format, print medium size, color options, types of delivery mechanisms, etc. In one example, each print service provider 18 pays a fee on a periodic basis (e.g., annual, monthly) to be placed on roster 112, assuming they meet the qualifications (set by intermediary 14), such as print capabilities, reliability, location, etc.

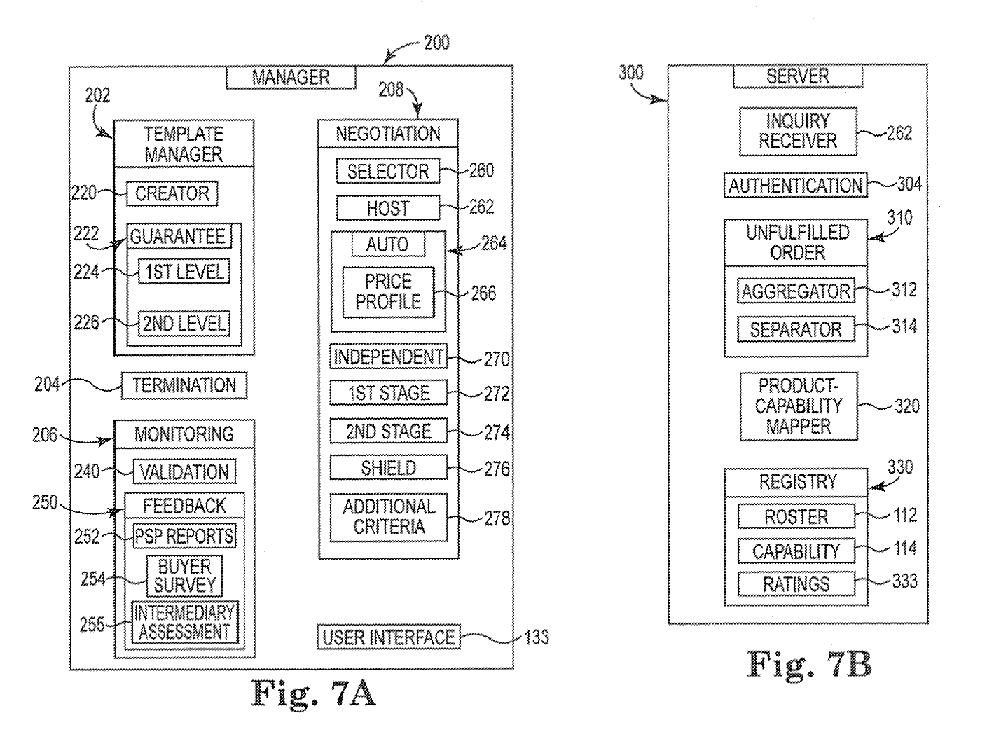

In some examples, intermediary 14 establishes eligibility of the print service providers 18 to be listed on roster 112 via a performance ratings function 333, as will be later described more fully in association with at least FIG. 7B.

In general terms, manager 120 supports and guides interaction between buyer 12 and print service providers 18 to negotiate terms for a printing job. In one example, the manager 120 comprises a first stage module 130, which includes a comparator 132 with non-price parameter 134, matching results function 136, and a terms-of-service function 138. The comparator 132 compares parameters of a job inquiry from the buyer relative to the capability profile of each print service provider 112 according to non-price terms per parameter 134. In other words, non-price parameter 134 causes comparator 132 to exclude price information when comparing the parameters of the job inquiry to the capability profile of the respective print service providers 112. This action produces a list of matching print service providers, as reported via function 136, which are ready, willing, and able to perform an order based on the service terms tracked via function 138.

In one aspect, the job inquiry is submitted by buyer 12 in the form of a search transmitted to manager 120 of server 100, and therefore received by intermediary 14. In some instances, intermediary 14 charges a fee to the buyer 12 for such searches. In one example, the results of the search take the form of intermediary 14 producing the list of “matching” print service providers 18 via matching results function 136, as noted above.

Accordingly, via first stage module 130 of manager 120, the server 100 facilitates a first stage of interaction between buyer 12 and print service providers 18 in which non-price terms of service for the job request are defined between the buyer 12 and any matching print service providers 18. In one aspect, it will be understood that this interaction is indirect in the sense that the buyer 12 and print service providers 18 do not interact directly with each other, but through intermediary 14. Nevertheless, the buyer 12 and print service providers 18 are interacting in a substantive manner based on whether each respective party agrees to the non-price service terms and based on whether the print service provider(s) 18 meets the qualifications (e.g. capability profile and/or performance ratings) to participate in the second stage.

In one embodiment, controller 104 comprises at least one processor and associated memories to generate control signals directing the operation of system 10 of FIG. 1 and/or server 100 of FIG. 2. In particular, in response to or based upon commands received via user interface 133 and/or machine readable instructions (including software) contained in the memory 102 associated with controller 104, controller 104 generates control signals directing operation of server 100 shown in FIG. 2. In one example, controller 104 is embodied in a general purpose computer.

For purposes of this application, in reference to the controller 104, the term “processor” shall mean a presently developed or future developed processor that executes sequences of machine readable instructions (such as but not limited to software) contained in a memory. Execution of the sequences of machine readable instructions causes the processor to perform actions, such as operating server 100 to function as an intermediary between a buyer and a print service provider in the manner described in the examples of the present disclosure. The machine readable instructions may be loaded in a random access memory (RAM) for execution by the processor from their stored location in a read only memory (ROM), a mass storage device, or some other persistent storage or non-volatile form of memory, as represented by memory 102. In one example, memory 12 comprises a computer readable medium providing non-volatile storage of the machine readable instructions executable by a process of controller 104. In other examples, hard wired circuitry may be used in place of or in combination with machine readable instructions (including software) to implement the functions described. For example, controller 104 may be embodied as part of at least one application-specific integrated circuits (ASICs). Unless otherwise specifically noted, the controller 104 is not limited to any specific combination of hardware circuitry and machine readable instructions (including software), nor limited to any particular source for the machine readable instructions executed by the processor 104.

In one example, user interface 133 of server 100 comprises a graphical user interface or other display that provides for the simultaneous display, activation, and/or operation of the various components, functions, features, and modules of server 100, described in association with at least FIG. 2. Moreover, it will be understood that the features, functions, modules, and components of the server 100 can be arranged in different forms and groupings, and therefore server 100 is not strictly limited to the particular arrangement or groupings of functions illustrated in FIG. 2.

FIG. 3A is a flow diagram schematically illustrating an example method 150 of facilitating print services. In general terms, method 150 includes at least one stage of in a method of facilitating print services and can be complemented with additional actions. In one example, method 150 is performed via the server 100 and the system 10, as previously described in association with FIGS. 1-2.

As shown at 152 in FIG. 3A, method 150 includes storing a capability profile for each print service provider of a plurality of print service providers. The respective capability profiles are matched, while excluding price information, relative to parameters of a job inquiry from a buyer, as shown at 154. Method 150 further includes setting non-price terms of a service level between the buyer and any matching print service providers, as shown at 156. In one example, the actions of storing the capability profile, matching capability profiles to a job inquiry, and setting non-price terms are performed by intermediary 14.

In one aspect, these aspects of method 150 complete a first stage of interaction between the buyer and the print service providers regarding how print services will be provided to the buyer.

FIG. 3B is a block diagram schematically illustrating an example capabilities profile 161. In one example, capabilities profile 161 includes at least substantially the same features and attributes as capability profile 114 in FIG. 2, and as such in general terms, the capabilities profile 161 specifies the capabilities of a print service provider 18. In one example, the capabilities profile 161 includes at least one of a print media parameter 160, a volume scale parameter 162, a color range parameter 163, a color quality parameter 164, a printer type parameter 165, a printing format parameter 166, a finishing parameter 167, and a shipping parameter 168. The print media parameter 160 specifies a type of print media while the volume scale parameter 162 specifies what volumes in a print job the print service provider can handle. The color range parameter 163 specifies the range of colors, including spot color availability. The color quality parameter 164 specifies the level of color quality available. The printer type parameter 165 specifies the types of printers available while the format parameter 166 specifies the different types of printing formats. The finishing parameter 167 specifies the types of finishing services while the shipping parameter 168 specifies the types and speed of shipping available. In other examples, some of these parameters are omitted from capabilities profile 161 or other parameters are added to capabilities profile 161. Accordingly, it will be understood that the capabilities listed in capabilities profile 161 are representative and are not an exhaustive list of all the capabilities of a print service provider 18.

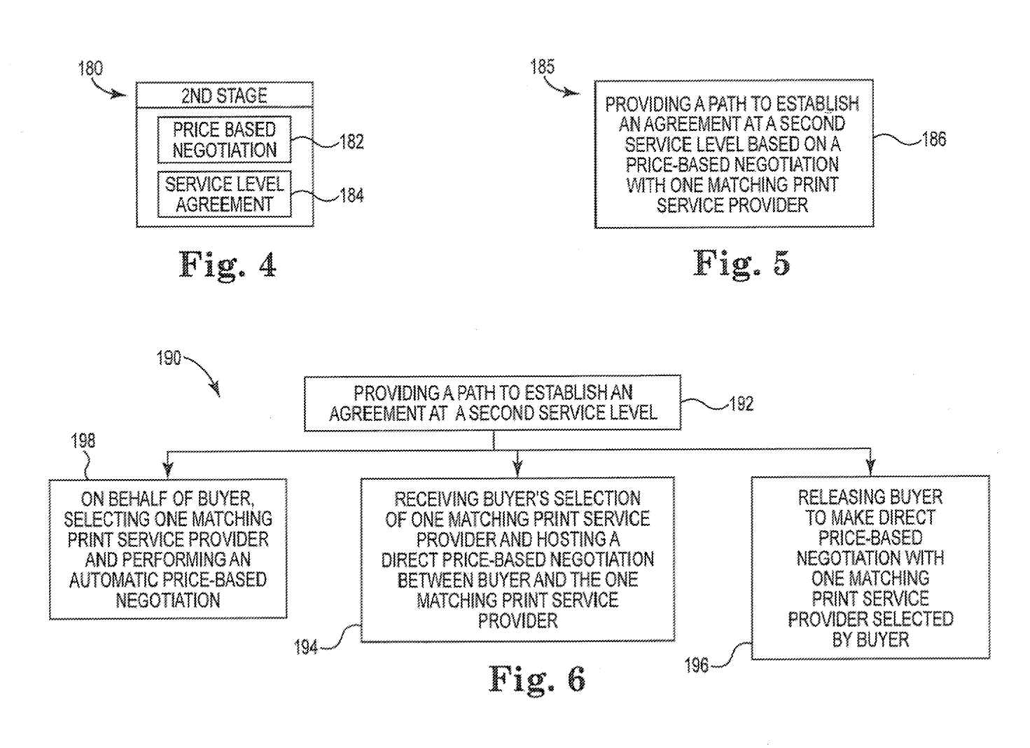

FIG. 4 is block diagram schematically illustrating an example second stage module 180 of a print service system. In one example, the second stage module 180 is operated in cooperation with, and follows operation of, the first stage module 130 of manager 120 of FIG. 2. In another example, second stage module 180 is included as a portion of manager 120 of server 100. As shown in FIG. 4, the second stage module 180 includes a price-based negotiation function 182 and a service level agreement function 184. The price-based negotiation function 182 provides a path for the buyer and one of the matched print service providers 18 to perform a negotiation, including price, regarding print services for the requested job. Upon a successful negotiation, service level agreement function 184 captures the terms of service between the buyer 12 and print service provider 18.

In one example, the print service provider 18 with whom negotiations take place is selected from among the matching print service providers 18, and therefore, the buyer 12 negotiates with just one matching print service provider 18 at a time.

In another example, the price-based negotiation further includes quantity terms and delivery terms, which are incorporated into the service level agreement.

FIG. 5 is a portion of a flow diagram schematically illustrating an example method 185 of facilitating print services. In general terms, method 185 is performed in cooperation with, and following, method 150 previously described in association with FIG. 3A. In one example, method 185 is performed via the system 10, server 100, and second stage module 180, as previously described in association with FIGS. 1-2 and 4. With this in mind, as shown at 186 in FIG. 5, method 185 includes providing a path to establish an agreement at a second service level based on a price-based negotiation with one matching print service provider.

FIG. 6 is a flow diagram schematically illustrating an example method 190 of facilitating print services. Method 190 (FIG. 5) provides several paths by which a buyer and one matching print service provider will arrive at an agreement regarding services terms, such as a service level agreement. Accordingly, in general terms, method 190 is substituted in place of method 185 (FIG. 5) and is therefore performed in cooperation with, and after, method 150 that was previously described in association with FIG. 3A. In one example, method 190 is performed via the system 10, server 100, and second stage module 180, as previously described in association with FIGS. 1-2 and 4.

As shown at 192 in FIG. 6, method 190 includes providing a path to establish an agreement at a second service level, which would incorporate the first level first service terms identified at 156 in method 150 (FIG. 3A). FIG. 6 illustrates three different paths provided by intermediary 14 and which may be taken by a buyer 12. In one path, as shown at 194 of FIG. 6, the intermediary 14 (acting via server 16, 100) receives the buyer's selection of which matching print service provider 18 with which it chooses to negotiate price-based terms of a service agreement. The intermediary 14 further hosts a price-based negotiation between the buyer 12 and the selected, matching print service provider 18.

In another path, as shown at 196 of FIG. 6, the intermediary 14 (acting via server 100) releases buyer 12 to make a price-based negotiation directly with one matching print service provider 18 selected by the buyer 12. In this example, the negotiation is performed independent of the intermediary 14 (and its server) through channels deemed suitable by the buyer 12 and selected, matching print service provider 18.

In another path, as shown at 198 in FIG. 6, the intermediary 14 (acting through its server 100) acts on behalf of the buyer 12 to select one of the matching print service providers 18 with whom to negotiate. After doing so, the intermediary 14 (via its server 100) performs an automatic price-based negotiation with the selected, matching print service provider 18. In some examples, the intermediary 18 permits the buyer 12 to select the matching print service provider 18, before the intermediary 141 performs the automatic price-based negotiation.

In one aspect, in order to enable the intermediary 14 to perform a quality negotiation, the intermediary 14 solicits from the buyer 12 a price profile that lists the prices, for various volumes of production, that buyer 12 is willing to accept. Using this price profile, the intermediary 14 negotiates (on behalf of the buyer 12) with the selected, matching print service provider 18 to arrive at a service level agreement between the buyer 12 and the selected, matching print service provider 18.

In another example, at the time the print service provider 18 requests to be added to roster 112 of registry 110 (FIG. 2), intermediary 14 solicits a price profile from print service provider 18 that is stored along with, and/or as part of, their capability profile 114 in registry 110. While the price information is not revealed or used in a first stage of negotiation, this price profile information is available for use by intermediary 14 during the automatic price-based negotiation with buyer 12 (and its stored price profile). In this way, in one example, the intermediary 14 can automatically perform the price-based negotiation between the buyer 12 and one matching print service provider 18.

Upon the conclusion of the price-based negotiation, the intermediary 14 produces the service level agreement (SLA) between the buyer 12 and print service provider 18 and the respective parties then proceed according to their respective rights and responsibilities according to the service level agreement.

FIG. 7A is a block diagram schematically illustrating an example manager 200 of a print service system. In one example, manager 200 operates in cooperation with, and complements, manager 120 of server 100 in FIG. 2. In another example, manager 120 incorporates, in a complementary fashion, the functions, components, and modules of manager 200. Accordingly, in one example, manager 200 is stored in memory 102 of server 100 and is executed, as machine readable instructions, via controller 104 of server 100.

In general terms, manager 200 is operated by server 100 to manage service terms and/or a service level agreement between the buyer 12 and one matching print service provider 18. In one example, the manager 200 acts to create the agreements, terminate the agreements, monitor the agreements, and/or negotiate the agreements.

As shown in FIG. 7A, in one example manager 200 includes a template manager 202, termination module 204, monitoring module 206, and negotiation module 208. Template manager 202 includes a creator function 220 and a guarantee function 222. The creator function 220 acts to create service level agreement template(s) used by a buyer 12, intermediary 14 via server 100, and/or print service providers 18. The template provides the basic terms of a service level agreement, with those terms being subjection to selection, rejection, modification by the respective parties (e.g. buyer, print service provider) depending upon the constraints imposed by intermediary 14 on such changes. In one example, the non-price service terms of the template are fixed by the intermediary prior to the first stage of interaction between buyer 12 and the print service providers 18.

The guarantee function 222 of manager 200 includes a first level parameter 224 and a second level parameter 226. In general terms, the guarantee function 222 establishes the basic terms, including guarantees, of service between the buyer 12 and the print service provider 18 with whom they contract. The first level parameter 224 establishes which terms are included in a first level agreement, such as which service terms are established during the first stage of interaction involving the buyer 12 and the print service providers 18. Those print service providers 18 having a capability profile that meets the service terms identified via first level parameter 224, consistent with the parameters of the specific job inquiry made by the buyer 12, are deemed to be matching print service providers 18. However, in some examples, the first stage of interaction includes the intermediary 14 applying additional criteria, such as the print service provider 18 meeting a minimum or threshold performance rating, provided via performance rating function 333 described later in association with at least FIG. 7B.

In one example, first level parameter 224 establishes at least one of the following guarantees: (1) no provider with a similar capability is preferred over another; (2) an existing capability is preferred over a future capability; (3) a print service provider cannot be a print service consumer for the same order; (4) print service providers will provide an accurate description of their capabilities, by providing updates at periodic intervals; (5) print service buyers determine the potential participants for the second stage; (6) communication via the system is limited to authenticated print service providers and print service buyers; (7) if a job does not match existing capabilities of the print service providers, the system caches the job and the job inquiry is available for other print service providers. Moreover, in one example, in the event that no print service provider 18 has a capability profile that exactly matches the parameters of the job inquiry, the intermediary 14 presents to the buyer 12 the print service provider 18 having the closest match.

In one aspect, these guarantees exist in addition to other terms of service such as the basic capabilities of a print service provider 18 as set forth in their capability profile 114, such as format type, ink type, color options, capacity, etc.

In general terms, second level parameter 226 sets forth the basic terms, in addition to the terms of service from the first stage per first level parameter 224, to which the buyer 12 and print service provider 18 agree in a final service level agreement. In one example, terms of service added in the second level will include information regarding price, quantity, and delivery. Moreover, in one example, second level parameter 226 of guarantee function 222 establishes at least one of the following guarantees: (1) the expected delivery date of the print artifact will be within x number of days; (2) the proofing date will be within y number of days of the buyer uploading the content; (3) delays from the buyer or from the buyer not approving the proofing will result in a renegotiation of the promised delivery date and terms of an existing service level agreement; (4) proper communication regarding delays from the print service provider in meeting expected delivery date and compensation of buyer by print service provider via faster shipping and/or discount on future orders; (5) process to handle failures by third parties, such as shipping entities.

It will be understood that other and/or additional guarantees can be included via second level parameter 226.

With further reference to FIG. 7A, termination module 204 of manager 200 governs termination of a service level agreement between a buyer 12 and a print service provider 18. For example, termination module 204 provides a process by which the respective parties can orderly discharge their remaining responsibilities to each other and any related communications.

As further shown in FIG. 7A, manager 200 includes monitoring module 206, which includes a validation function 240 and a feedback function 250. In general terms, via validation function 240, the monitoring module 206 enables the intermediary 14 to track the performance and behavior of the buyer 12 and print service provider 18 in carrying out the service level agreement between them. In general terms, the feedback module 250 of monitoring module 206 provides a mechanism for the buyer 12 and/or the print service provider 18 to give feedback regarding their satisfaction with the service level agreement via a performance rating and/or other commentary.

In one example, as shown in FIG. 7A, the feedback module 250 includes a print service provider (PSP) report function 252, a buyer survey function 254, and an intermediary assessment function 255. The print service provider report function 252 ensures that the print service provider 18 makes reports to the intermediary 14 (acting via server 100) at periodic intervals. The buyer survey function 254 enables the intermediary 14 to prompt the buyer 12 to complete a survey, provided by the intermediary 14, to rate the performance of the print service provider 18. The intermediary assessment function 255 enables the intermediary 14 to provide its own assessment of the performance of each print service provider 18. This assessment can incorporate the buyer's rating of the print service provider 18 or be independent of the buyer's ratings of the print service provider 18. In addition, in another aspect, the intermediary's assessment incorporates information from the print service provider's periodic reporting.

In one example, the information gathered by intermediary 12 via functions 252, 254, 255 of feedback module 250 is used to produce a performance rating for each print service provider 18 and that is stored via a performance ratings function 333 in a registry along with the capability profile 114, as later described and illustrated in association with FIG. 7B.

As further shown in FIG. 7A, manager 200 includes a negotiation module 208. In general terms, negotiation module 208 enables and guides negotiations between the buyer 12 and the print service provider 18, and in some examples, provides a mechanism for the intermediary 14 to assist the buyer 12 in such negotiations.

As shown in FIG. 7A, in one example, negotiation module 208 includes a selector function 260, host mode 262, auto mode 264, and independent mode 270. Moreover, in some examples, negotiation module 208 includes a first stage function 272, a second stage function 274, shield function 276, and additional criteria function 278.

In one example, the first stage function 272 comprises at least substantially the same features and attributes as first stage module 130 of manager 120 as previously described in association with FIG. 2. In another example, the second stage function 274 comprises at least substantially the same features and attributes as second stage module 180 as previously described in association with FIG. 4.

In one example, the selector function 260 provides a path for the buyer 12 to select a matching print service provider 18 as the entity with which to negotiate a service level agreement. The selector function 260 also provides a mechanism for the intermediary 14 to select the print service provider 18 when the buyer 12 delegates such authority.

As previously described in association with at least FIG. 6, intermediary 14 provides different modes of negotiation. In particular, host mode 262 of negotiation module 208 provides for the intermediary 14 (via server 100) to host the negotiation between the buyer 12 and the selected, matching print service provider 18. In this arrangement, buyer 12 communicates directly with intermediary 14 and print service provider 18 communicates directly with intermediary 14, but buyer 12 does not communicate directly with print service provider 18 during the negotiations.

Auto mode 264 of negotiation module 208, as shown in FIG. 7A, includes the intermediary 14 participating in a negotiation on behalf of the buyer 12 by which an automatic negotiation takes place between the server 100 of intermediary 14 and the print service provider 18. In one aspect, the auto mode 264 includes a price profile parameter 266 by which a buyer communicates its preferences regarding price (at different volumes) to the intermediary 14 to equip the intermediary 14 to perform the negotiation. As previously noted in association with capability profile 114 of registry 110 in FIG. 2, the print service provider 18 also can communicate a pricing profile to the intermediary 14 at some point in time before the automatic negotiation, thereby facilitating a completely automatic negotiation performed by intermediary 14 on behalf of both buyer 12 and print service provider 18.

In independent mode 270 of negotiation module 208, the intermediary 14 releases the buyer 12 to directly negotiate with the print service provider 18, independent of the intermediary 14.

Whether the negotiation takes place via the host mode 262, the auto mode 264, or the independent mode 270, it will be understood that in one example, the term “negotiation” includes a multi-round process involving offers and counter-offers by the respective buyer 12 and print service provider 18. This arrangement stands in contrast with some existing bid models where mere acceptance of a bid takes place.

In some examples, negotiation module 208 also includes shield function 276, which acts to hide or shield the identity of the buyer 12 during the first stage of interaction with the print service providers 18. In another example, the shield function 276 is employed in a second stage of interactions (e.g. during price-based negotiation) between the buyer 18 and one matching print service provider 18, such as when the auto mode 264 of negotiation takes place with the intermediary 14 acting on behalf of the buyer 12.

In another example, negotiation module 208 includes an additional criteria function 278, by which the intermediary 14 invites the buyer 12 to specify additional criteria at the end portion of the first stage of negotiations to further sort matching print service providers 18. In one example, such additional criteria 278 includes, but is not limited to, a proximity of the print service provider to buyer location, reviews from social media and networks, and/or past history with the print service provider, etc.

In one aspect, as shown in FIG. 7A, manager 200 includes a user interface 133.

FIG. 7B is a block diagram schematically illustrating an example server 300. In one example, server 300 includes at least substantially the same features and attributes as server 100, second stage module 180, and manager 200, as previously described in association with FIGS. 2, 4, and 7A, respectively. Accordingly, in general terms server 300 provides alternate and/or additional functions and modules to the server 100, second stage module 180, and manager 200.

As shown in FIG. 7B, server 300 includes an inquiry receiver function 302, authentication function 304, an unfulfilled order module 310, and a product-capability mapper 320. The inquiry receiver function 302 equips the intermediary 14 to invite and receive job inquiries and requests from a buyer 12. The authentication function 304 equips the intermediary 14 to provide authentication of print service providers 18 and/or buyers 12 via a token or other authenticating tool such that each communication or interaction involving the print service providers 18 and buyers 18 is secure via authentication.

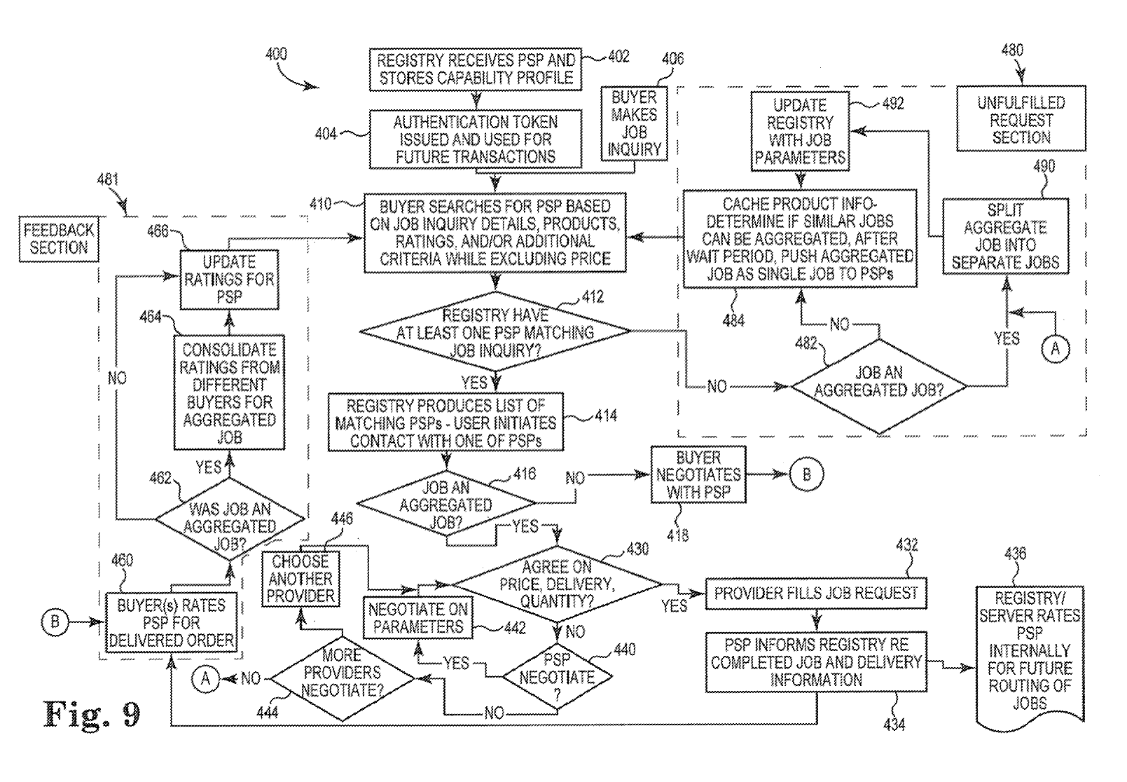

In general terms, the unfulfilled order module 310 provides a path for the intermediary 14 to address job inquiries or orders that are not matched with a print service provider 18, and therefore, go unfulfilled. One example by which the unfulfilled order module 310 operates is later described in association with FIG. 9. As shown in FIG. 7B, the unfulfilled order module 310 includes an aggregator function 312 and a separator function 314. The aggregator function 312 acts to aggregate job requests or inquiries that were previously unfulfilled and the aggregated job is then resubmitted as a single job inquiry as viewed by the print service provider 18. Accordingly, with this arrangement, previously unfulfilled job requests no longer languish due to lack of interest by print service providers 18.

The separator function 314 of unfulfilled order module 310 is available to separate an aggregated job in the event that an aggregated job submitted to the first stage of negotiation also goes unfulfilled. In this instance, the intermediary 14 uses separator function 314 to disassembly the aggregated job into separate jobs, which are each resubmitted to the first stage matching process.

The product-capability mapper 320 takes parameters of an incoming job inquiry or request and translates those parameters into capabilities in the format used by print service providers 18 in detailing their capability profile 114 stored in registry 110. In one example, the product-capability mapper 320 applies at least some of the capabilities specified by capability profile 161 in FIG. 3B to sort and normalize capabilities of each print service provider 18 relative to parameters of the job inquiry from the buyer 12. In one aspect, the product-capability mapper 320 can receive perform this function regardless of whether the job inquiries are brief and general or are highly specific and detailed. In this way, job inquiries can then be compared in a meaningful, consistent manner to the capabilities of the various print service providers 18. In one example, the product-capability mapper 320 is able to prompt a print service provider 18 to provide more information about a particular capability, depending upon the clarity of information provided by the print service provider 18.

In one example, server 300 includes registry 330, which has substantially the same features and attributes as registry 110 of server 100 of FIG. 2, except with registry 330 additionally including a performance ratings function 333. The performance ratings function 333 stores rating information about print service providers 18 that is generated via print service provider reports function 252, buyer survey function 254, and/or intermediary assessment function 255 of feedback module 250 (of manager 200 of FIG. 7A), as previously described.

It will be understood that the features and components of the manager 200 (FIG. 7A) and server 300 (FIG. 7B) can be arranged in different forms and groupings, and therefore each of manager 200 and server 300 are not strictly limited to the particular arrangement or groupings of functions illustrated in FIGS. 7A and 7B.

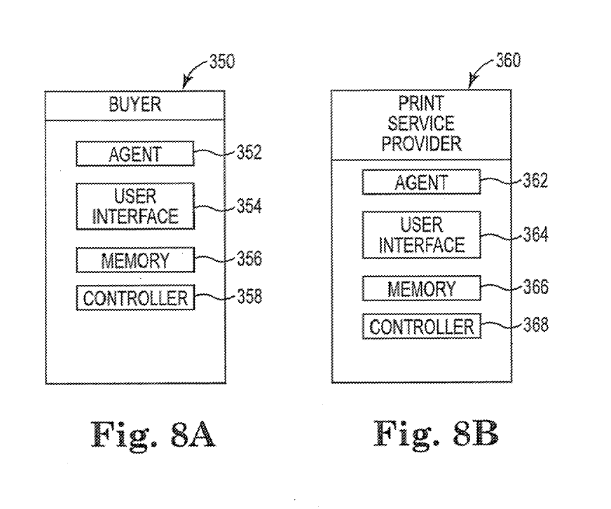

FIGS. 8A and 8B are block diagrams schematically illustrating an example buyer 350 and an example print service provider 360, respectively. In one example, the buyer 350 and the print service provider 360 include at least substantially the same features and attributes as buyer 12 and print service provider 18, as previously described in association with FIGS. 1-7B.

As shown in FIG. 8A, buyer 350 includes an agent 352, user interface 354, memory 356, and controller 358. In one aspect, memory 356 and controller 358 include generally the same features and attributes as memory 102 and controller 104 of server 100 (FIG. 2), except with memory 356 and controller 358 directed to supporting and controlling the function of buyer 350 instead of server 100. Likewise, user interface 354 comprises substantially the same features and attributes as user interface 133 of manager 120 (and of server 100), except for enabling buyer 12 to interact with intermediary 14 and print service providers 18 in a manner consistent as previously described in association with FIGS. 1-7B.

Agent 352 comprises an electronic module through which the actual buyer (a human or plurality of humans) electronically interacts with corresponding agents of intermediary 14 (e.g. server 100) and print service provider 18, with agent 352 containing machine readable instructions (including software) stored in memory 356 and executed via controller 358 to provide the functions of buyer 12 as part of print service system 10.

As shown in FIG. 8B, print service provider 360 includes an agent 362, user interface 364, memory 366, and controller 368. In one aspect, memory 366 and controller 368 include generally the same features and attributes as memory 102 and controller 104 of server 100 (FIG. 2), except with memory 366 and controller 368 directed to supporting and controlling the function of print service provider 360 instead of server 100. Likewise, user interface 364 comprises substantially the same features and attributes as user interface 133 of manager 120 (and of server 100), except for enabling print service provider 18 to interact with intermediary 14 and buyer 12 in a manner consistent as previously described in association with FIGS. 1-7B.

Agent 362 comprises an electronic module through which the actual print service provider (a human or plurality of humans) electronically interacts with corresponding electronic agents of intermediary 14 and buyer 12, with agent 352 containing machine readable instructions (including software) stored in memory 356 and executed via controller 358 to provide the functions of print service provider 18 as part of print service system 10.

FIG. 9 is a flow diagram schematically illustrating an example method 400 of facilitating print services. In one embodiment, method 400 is performed via the systems, components, modules, and functions previously described in association with FIGS. 1-8B, and by which the intermediary 14 hosts and/or directs the actions performed in method 400.

As shown in FIG. 9, at 402 method 400 includes an intermediary receiving, into a registry, a print service provider as a registrant and storing a capability profile of the respective print service provider. In one aspect, the intermediary provides access to the registry via membership on a calendar basis (e.g. annual, semiannual, monthly, etc.), which is controlled by the owner of the registry, such as the intermediary that owns and/or controls the server (e.g. server 100 in FIG. 2). For the print service providers, among other benefits, membership in the registry provides access to service level agreement templates regarding defined capabilities, access to information about services sought by buyers, and strategies for automated negotiations.

At 404 in method 400, the intermediary issues an authentication token to a registered print service provider, which is used in all future transactions and communications via the system. At 406, a buyer submits a job inquiry. In one example, each communication made by the buyer is also subject to an authentication token issued by the intermediary to the buyer.

At 410, method 400 includes the intermediary receiving a search by the buyer for a print service provider based on non-price factors, such as parameters of the job inquiry, available products, performance ratings about the print service providers, etc.

At 412, method 400 includes determining if the registry has a print service provider with a capability profile that matches the job inquiry search submitted by the buyer (as at 410). If the query is answered negatively (the NO pathway), then the flow proceeds to an unfulfilled request section 480, which will later be described more fully. If the query is answered positively (the YES pathway), then the flow proceeds with the intermediary (via registry) producing a list of matching print service providers. The buyer then selects one matching print service provider and initiates contact with them. This action is followed by another query at 416 on whether the submitted job inquiry is an aggregated job.

If the answer to the query at 416 is negative (the NO pathway) such that the job is not an aggregated job, then the intermediary releases the buyer to negotiate with the selected, matching print service provider, as shown at 418. In addition, after the negotiation is completed at 418, the flow proceeds to a feedback section 481, whose starting point as represented by the circle B at 460.

In the feedback section 481, beginning at 460, method 400 includes the intermediary receiving a rating from buyer regarding the performance of the print service provider that completed the requested job. As shown at 462, the intermediary queries whether the job was an aggregated job. If the query is answered affirmatively (the YES pathway), then at 464 the intermediary consolidates ratings regarding the print service provider's performance from the different buyers whose job formed a portion of the aggregated job. This action is followed at 466 by the intermediary updating the ratings for the print service provider based on the feedback from the multiple different buyers.

On the other hand, if the query at 462 is answered negatively (the NO pathway), then at 466 the intermediary updates the ratings for the print service provider without having to consolidate the ratings from different buyers.

Upon completion of the flow through the feedback section 481, method 400 resumes at 410 with another buyer search and submission of a job inquiry.

However, with further reference to the main flow of method 400 at query 416, if the query is answered affirmatively (the YES pathway) that the job is an aggregated job, then the flow includes another query at 430 regarding whether an agreement was reached on price, quantity and/or delivery factors. In this context, in one example, the intermediary acts on behalf of the multiple buyers (whose separate print jobs make up the aggregated job) in negotiating with a print service provider. Moreover, this query 416 allows for the possibility that an agreement can be reached based on preset price profiles established by the buyers and print service provider. However, assuming that such preset price profiles are not present in a particular case, then an agreement would not have been reached prior to query 430.

If this query at 430 is answered affirmatively (the YES pathway), then the print service provider performs the requested job as shown at 432. This action is followed by the intermediary receiving feedback from the print service provider, which informs the registry that the job was completed and informs the registry regarding delivery information, as shown at 434. In one aspect, the intermediary makes its own internal rating of the performance of the print service provider for the intermediary to use in routing and assigning future job requests, as shown at 436.

With further reference to the main flow of method 400, if the query at 430 is answered negatively (the NO pathway), the intermediary determines whether the print service provider is willing to negotiate, as shown at 440.

If the answer to the query at 440 is answered positively (the YES pathway), then the intermediary directs that a negotiation over parameters take place with the print service provider, as shown at 442. In one example, on behalf of the multiple buyers (whose separate jobs form the aggregated job), the intermediary negotiates with the print service provider. The results of the negotiation flow into query 430 regarding whether an agreement has been reached regarding price, quantity, and delivery.

However, if the answer to the query at 440 is answered negatively (the NO pathway), then the intermediary determines whether more or other print service providers are willing to negotiate, as shown at 444. If this query at 444 is answered negatively, then the flow of method 400 jumps (represented by circle A) to the unfulfilled request section 480, where the aggregated job is split into separate jobs at 490. Further details regarding the unfulfilled order section 480 are later described more fully.

With further reference to the flow of the method at 444, if this query at 444 is answered positively, then method 400 includes the intermediary choosing (or permitting the buyer to choose) another provider with whom negotiations can take place, as shown at 446.

With further reference to the query at 412, in the event that the query is answered negatively (the NO pathway), then method 400 includes making a query at 482, as part of the unfulfilled request section 480, regarding whether the job (for which no matching print service providers were identified) is an aggregated job.

If the query at 482 (in unfulfilled order section 481) is answered positively (the YES pathway), then the intermediary splits the aggregated job into separate jobs, as shown at 490. From here, method 400 includes updating the registry with the parameters of the various separate jobs, as shown at 492. At 484, the product information is cached and tracked to periodically determine if similar jobs can be aggregated. After a wait period, an aggregated job is pushed to the flow at 410 in which the aggregated job is submitted as a single job.

If the query at 482 is answered negatively (the NO pathway) that the unfulfilled job request is not an aggregated job, then the intermediary caches the product information to determine if similar jobs can be aggregated, and if similar jobs are identified, then the intermediary aggregates those separate jobs into a single job to be submitted to the flow at 410.

The process of aggregating or disassembling jobs is repeated until all the jobs are fulfilled or a buyer withdraws a job inquiry.

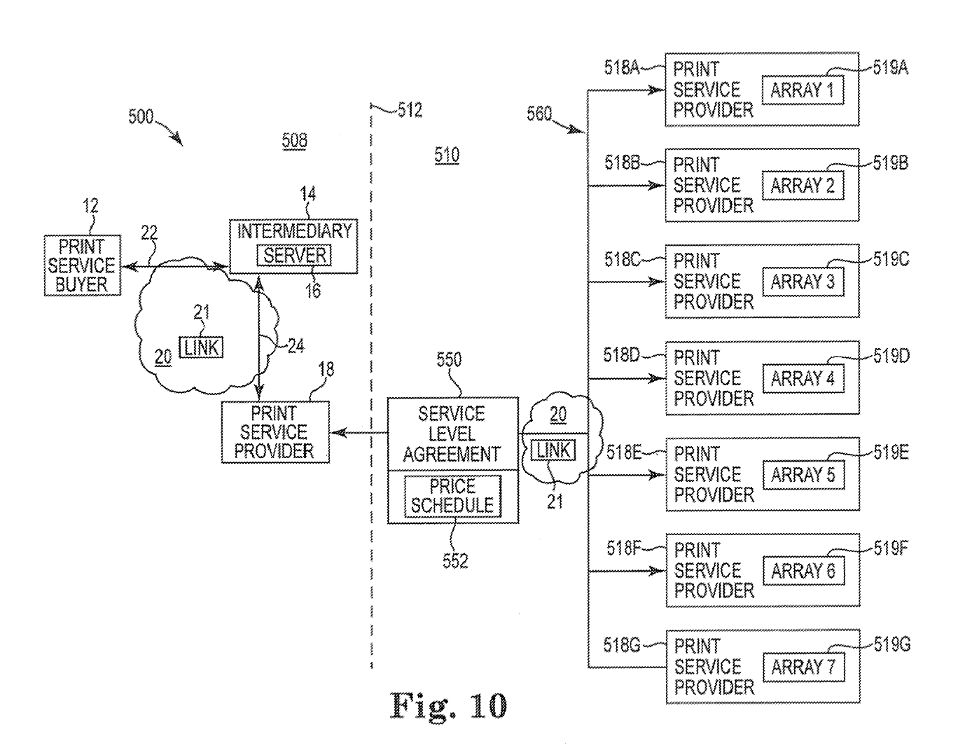

FIG. 10 is a block diagram schematically illustrating a block diagram of an example printing system 500. As shown in FIG. 10, system 500 includes a front end portion 508 and a back end portion 510, which are schematically separated via dashed line 512. In one example, the front end portion 508 includes at least substantially the same features and attributes as the example print service systems and methods as previously described in association with FIGS. 1-9. Accordingly, after a first, non-price stage of interaction, buyer 12 selects a matching print service provider 18 to enter into a price-based negotiation toward the goal of arriving at a service level agreement between buyer 12 and the selected print service provider 18. However, unknown to buyer 12, print service provider 18 contracts out at least some of its capabilities, functions, and/or infrastructure.

Accordingly, in general terms, the back end portion 510 comprises a mechanism for print service provider 18 to provide a wide range of services to buyer 12 without print service provider 18 having to actually perform each and every aspect of the service level agreement with buyer 12.

As shown in FIG. 10, print service provider 18 is in communication, via cloud 20, with an array 560 of print service providers 518A-518G. The print service provider 18 has a service level agreement with the print service providers 518A-518G according to a fixed price schedule 552 for the services rendered by print service providers 518A-518G. Accordingly, based on this relationship expressed via the service level agreement 550, print service provider 18 is equipped to negotiate in system 10 with buyer 12 and/or intermediary 14.

Each print service provider 518A-518G includes an array of services 519A-519G, respectively. In one example, while the respective print service providers 519A-519G include at least some of the same services and capabilities, at least some of the print service providers 519A-519G include services and capabilities different than other print service providers 519A-519G. As one non-limiting example, some of the print service providers 518A-518G might include large format printing capability, while others do not. Some of the print service providers 518A-518G might include large volume finishing services, while other print service providers 518A-518G do not. Nevertheless, via service level agreement 550, print service provider 18 can act as a single contact to buyer 12 in the front end portion 508 of system 500 and unbeknownst to buyer 12, print service provider 18 combines the capabilities (e.g. large format printing, large volume finishing) of different print service providers 518A-518G in a complementary and integrated solution for buyer 12. In this way, the print service provider 18 functions somewhat like a general contractor who hires subcontractors, such as print service providers 518A-518G. Accordingly, it will be understood that print service provider 18 selects the print service providers 518A-518G so that at least some of the print service providers 518A-518G offer different types of services from each other, but in a complementary manner so that a full range of, or the desired combination of, print services is represented by array 560.

In one aspect, in responding to a job inquiry from buyer 18 in the front end portion 508 of system 500, print service provider 18 can quickly and easily combine capabilities (in the back end portion 510 of system 500) from different print service providers 518A-518G at least because the pricing for the services provided by print service providers 518A-518G already has been pre-negotiated and is expressed in price schedule 552.

This arrangement produces a more robust and diverse printing services market by enabling smaller entities to compete with larger entities via the smaller entity acting as a bundler of services. Moreover, this arrangement prevents underutilization of smaller entities that could otherwise occur if large entities are allowed to dominate a market by their wider range of services. At the same time, the buyer is able to engage a single contact, namely, print service provider 18 via intermediary 14. By promoting more competition, the print services market benefits with better service and different types of service.

Because system 500 enables print service provider 18 to dynamically group desired capabilities together from among the print service providers 518A-518G of array 560, system 500 increases the likelihood that buyer 12 will find a matching print service provider 18. Moreover, by enabling print service provider 18 to construct a portfolio of capabilities on an “as needed” basis via its network of providers 518A-518G, system 500 increases the diversity of the printing services market because smaller entities such as print service providers 518A-518G can effectively participate in a market that would otherwise be dominated by large entities capable of providing all the services potentially requested by buyer 12.

Examples of the present disclosure provide for a multi-stage negotiation by which price factors are excluded from consideration in a first stage of identifying potential print service providers capable of performing a requested print job and then included in a second stage in which a negotiation occurs with a single print service provider to arrive at a service level agreement between the buyer and the print service provider.

Although specific examples and embodiments have been illustrated and described herein, it will be appreciated by those of ordinary skill in the art that a variety of alternate and/or equivalent implementations may be substituted for the specific embodiments shown and described without departing from the scope of the present disclosure. This application is intended to cover any adaptations or variations of the specific embodiments discussed herein. Therefore, it is intended that this present disclosure be limited only by the claims and the equivalents thereof.

What is claimed is:

1. A print service system comprising:
a server including a non-volatile memory to store, and a processor to execute, machine readable instructions to provide:
a registry to store a capability profile of each print service provider of a plurality of print service providers; and
a manager including:
a first stage module to identify matches, while excluding price information, between the capability profile of each respective print service provider and a job inquiry from a buyer and to set non-price service terms; and
a second stage module to provide a path for a price-based negotiation with one matching print service provider to produce a price-based services level agreement, incorporating the non-price service terms, between the buyer and the one matching print service provider.

2. The system of claim 1, wherein the second stage module enables the buyer to select the one matching print service provider and releases the buyer to perform the price-based negotiation directly with the selected, matching print service provider and independent of the server.

3. The system of claim 1, wherein the second stage module enables the buyer to select the one matching print service provider and hosts the price-negotiation between the buyer and the selected, matching print service provider.

4. The system of claim 1, wherein the second stage module includes an automatic negotiation function, and wherein the server, on behalf of the buyer, performs the price-based negotiation with the one matched print service provider according to at least a price profile set by the buyer.

5. The system of claim 1, wherein the second stage module includes at least one of:
a first feedback function to command the print service provider to send feedback, at periodic intervals, regarding the services level agreement with the buyer, and
a second feedback function to initiate a performance survey to the buyer to enable rating performance of the print service provider.

6. The system of claim 1, wherein the first stage module hides an identity of the buyer from the print service providers and wherein the second stage module reveals the identity of the buyer to the one matching print service provider.

7. The system of claim 1, wherein both the price-based negotiation and the price-based services level agreement also includes a quantity parameter and a delivery date parameter.

8. The system of claim 1, wherein the first stage module includes a product capability mapping module to sort and normalize capabilities of each print service provider relative to parameters of the job inquiry from the buyer, wherein the capabilities include at least one of:
a print media parameter;
a volume scale parameter;
a color range parameter;
a color quality parameter;
a printer type parameter;
a finishing parameter; and
a shipping parameter.

9. A print service system comprising:
a server including a non-volatile memory to store, and a processor to execute, machine readable instructions to provide:
an inquiry communications module to receive and process a job inquiry from a buyer; and
a registry to store a capability profile of each print service provider of an array of print service providers and to store a performance rating for each respective print service provider;
a capability matcher to automatically perform matching between the respective capability profiles and parameters of the job inquiry;
a first agreement module, in cooperation with the capability matcher, to produce a non-price, first service level agreement between the buyer and matching print service providers;
a second agreement module to produce a negotiated second service level agreement, incorporating the first service level agreement, between the buyer and a respective one of the matching print service providers, wherein the respective matching print service provider is selected at least based on the performance rating, and wherein the second service level agreement includes information regarding price, quantity, and delivery.

10. The system of claim 9, wherein the one matching print service provider in the second services level agreement is selected by the buyer from among the matching print service providers identified by the first agreement module, and wherein the second agreement module hosts a price-based negotiation between the buyer and the respective matching print service provider.

11. The system of claim 10, wherein the server comprises:
a feedback function by which an intermediary operating the server assigns the performance rating to each respective print service provider, at least based on feedback from at least one prior buyer regarding past jobs performed by the respective print service provider.

12. The system of claim 9, wherein the one matching print service provider in the second services level agreement is selected by an intermediary operating the server and the second module includes an automatic negotiation function to cause the server, on behalf of the buyer, to automatically perform the price-based negotiation with the selected, matched print service provider according to at least a price profile set by the buyer.

13. A method of acquiring print services comprising:
providing a server including a non-volatile memory to store, and a processor to execute, machine readable instructions to cause:
receiving, at the server, a job inquiry from a buyer;
storing, in a registry of the server, a capability profile of each print service provider of a first array of print service providers;
authenticating each communication at the server from the buyer and from the print service providers;
comparing the capability profile of the respective print service providers of the first array relative to parameters of the job inquiry from the buyer, wherein the comparing excludes price information;
upon determining a match between the job inquiry and any of the respective print service providers, producing a first non-price, services level agreement between the buyer and each matching print service provider; and
at least one of:
releasing the buyer to perform a price-based direct negotiation with one matching print service provider, selected by the buyer, to form a second price-based, services level agreement, incorporating the first services level agreement, between the buyer and the selected, matching print service provider; and
hosting a price-based negotiation with one matching print service provider, selected by the buyer, to form a second, price-based services level agreement, which incorporates the first services level agreement, between the buyer and the selected print service provider.

14. The method of claim 13, wherein hosting the price-based direct negotiation includes the server acting as a substitute for the buyer and automatically performing the price-based negotiation with the selected, matching print service provider according to a price profile set by the buyer.

15. The method of claim 13, wherein the job inquiry comprises an aggregated job inquiry incorporating previously unfulfilled job inquiries from different buyers.
